(19) United States
(12) Patent Application Publication
(10) Pub. No.: US 2008/0164338 A1
(43) Pub. Date: Jul. 10, 2008

(54) Fluid applicator color identification

(76) Inventor: Marvin D. Burns, Millbury, OH (US)

Correspondence Address: DINSMORE & SHOHL LLP, ONE DAYTON CENTRE, ONE SOUTH MAIN STREET, SUITE 1300, DAYTON, OH, 45402-2023, US

(21) Appl. No.: 11/640,569

(22) Filed: Dec. 18, 2006

(51) Int. Cl. B67D 5/08

(52) U.S. Cl. 239/71; 239/379

(57) ABSTRACT

A fluid applicator. The fluid applicator includes a body having a nozzle and trigger and optionally at least one part connected to the body, the body having a groove therein; and a removable color-coded identification clip made of a flexible material positioned in the groove in the body. The invention also involves a method of identifying a fluid applicator.

### BACKGROUND OF THE INVENTION

The present invention is directed generally to a fluid applicator, and more particularly to a fluid applicator having an identification system.

Many spray painting businesses employ more than one painter. This results in more than one spray gun being used. Even when there is only one painter, there may be more than one spray gun because painters often use one spray gun for the base coat and another for the clear coat. In these situations, it can be desirable to identify a particular spray gun as belonging to a particular individual or to a particular product.

One method of identifying spray guns involves permanently engraving the spray gun with a person's initials. However, if the person changes jobs or leaves the company, the initials cannot be changed. Another set of initials would have to be added. The limited space on the spray gun for engraving could make it difficult to identify the current user. In addition, a special tool must be used for engraving.

Another method involves a plastic ring which is permanently attached at the factory to the connection between the nozzle and the gun body. If a customer receives two guns having the same color ring, there is no way to distinguish between the guns because the ring is permanently attached.

Another method involves attaching a colored molded plastic pad to the bottom of the spray gun using a screw. A package with a variety of colors is provided. However, attaching or changing the plastic pad requires the use of a tool.

Therefore, there remains a need for a simple, easy to use, identification system for fluid applicators.

### SUMMARY OF THE INVENTION

The present invention meets this need by providing an identification clip which can be attached to the fluid applicator without the use of a tool. The fluid applicator includes a body having a nozzle and trigger and optionally at least one part connected to the body, the body having a groove therein; and a removable color-coded identification clip made of a flexible material positioned in the groove in the body. By “removable,” we mean removable without the use of a tool.

Another aspect of the invention is a fluid applicator including a body having a nozzle, a trigger, and optionally at least one part connected to the body; and a removable color-coded identification clip made of a flexible material, the identification clip being snapped onto the body.

Another aspect of the invention is a method of identifying a fluid applicator. The method includes providing a fluid applicator having a groove therein; selecting a removable color-coded identification clip made of a flexible material; and inserting the identification clip in the groove in the fluid applicator.

### BRIEF DESCRIPTION OF THE DRAWINGS

FIG. 1 is side elevation view of a gravity-feed paint sprayer with the identification clip of the present invention.

FIG. 2 is a top plan view of the identification clip according to the present invention.

### DETAILED DESCRIPTION OF THE INVENTION

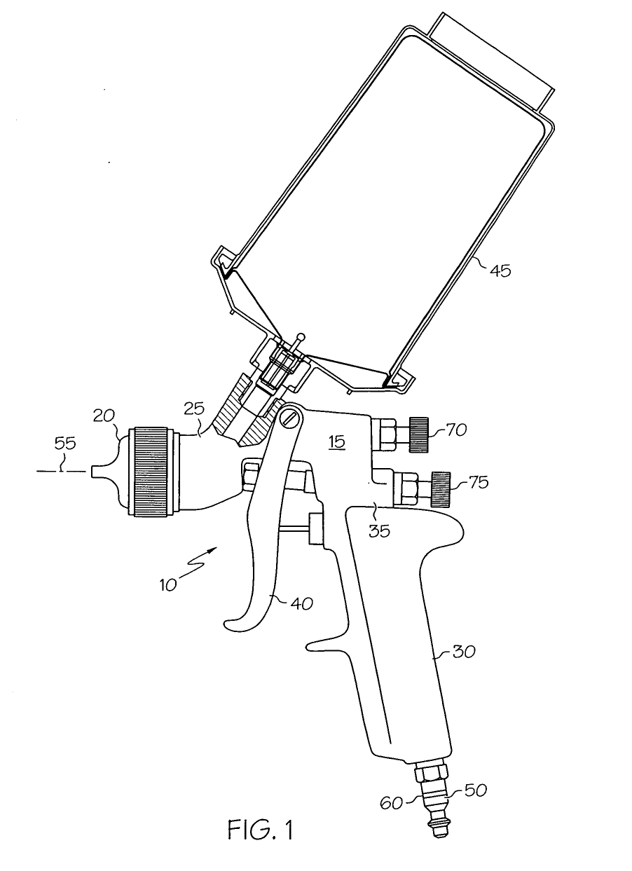

A fluid applicator with a fluid supply assembly attached is shown in FIG. 1. In one embodiment, the fluid applicator can be a paint sprayer. The present invention will be described for a paint sprayer, such as a gravity feed or suction feed paint sprayer for use in applying paint to coat substrate surfaces. The paint sprayer can be used in the automotive refinishing market, such as automobile body shops, for repainting automobiles. Although the fluid supply assembly is described for a paint sprayer, it is not limited to such use. It can be used for supplying other flowable liquids, including, but not limited to, beverages, foods, condiments (such as ketchup), gasoline, petrochemicals and hydrocarbons, water, water-based solutions, solvent-based solutions, emulsions, adhesives, and the like.

Referring to FIG. 1, a paint sprayer 10 is shown. It includes a body 15, a nozzle assembly 20 secured to a front end 25 of body 15, and a handle 30 depending from a rear end 35 of body 15. A trigger 40 is pivotally secured to body 15 for the manual actuation of sprayer 10. A top-mounted paint supply assembly 45 is mounted to body 15 near front end 25 for feeding paint to nozzle assembly 20. An air inlet fitting 50 is connected to an air hose (not shown) for the delivery of pressurized air to nozzle assembly 20, wherein the delivery of pressurized air is controlled by trigger 40. There can be one or more parts, including, but not limited to, the knob for the fan control valve 70, and the adjusting knob 75, connected to the body. Fan control valve 70 controls the size of the spray pattern. Adjusting knob 75 controls how far the fluid needle opens, which controls how much fluid is sprayed. The parts can be connected to the body in any suitable way, including but not limited to, using threaded connections.

Compressed air from air inlet fitting 50 is delivered through an internal passage (not shown) to nozzle assembly 20 and the compressed air acts to atomize paint and deliver it through nozzle assembly 20 to spray paint about paint axis 55. Paint is delivered to nozzle assembly 20 from paint supply assembly 45.

The air inlet fitting 50 includes a groove 60. The identification clip 65 is placed in the groove 60. The identification clip 65 can be made of a flexible material. Suitable flexible materials include, but are not limited, to plastic, and rubber. The plastic can be any suitable plastic, including, but not limited to, acetal, polyethylene, nylon, and the like.

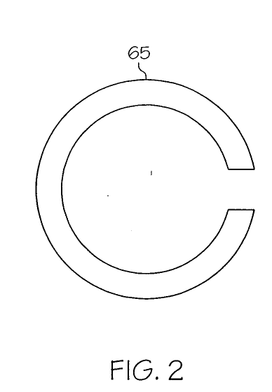

The shape of the identification clip will depend on where it is to be attached. The identification clip can be slipped over various parts of the spray gun. The identification clip could be a continuous ring (or other continuous shape). Alternatively, the ring could be split or have a space between the ends to allow it to be placed around a part more easily. One embodiment of the identification clip is shown in FIG. 2. A C-shaped identification clip is suitable for many locations and is easy to make. The space between the ends allows the identification clip 65 to flex so that it can be inserted and removed from the groove easily. Other locations for the groove, such as on a hex head, would call for a different shape for the identification clip. Suitable shapes include, but are not limited to, square, hexagonal, and circular.

Alternatively, the groove can be located elsewhere on the spray gun, including, but not limited to, on any round part or any hexagonal shaped part. Examples include, but not limited to, the trigger, the handle, the nozzle, the body bushing, the air valve, and hexagonal heads on parts which are threaded into the body. The groove should be wide enough so that the identification clip can be easily placed in the groove. The groove is typically in the range of about 0.5 to about 5 mm, although it could be narrower or wider if desired.

The identification clip could also be positioned on various parts of the spray gun without being placed in a groove. In this arrangement, the identification clip would be around a portion of the fan control valve, for example. The head of the fan control valve could retain the identification clip. In some arrangements (for example, where the identification clip is placed on the head of the fan control valve or on the trigger), the identification clip may be more likely to be removed inadvertently than when the groove is used because there is no groove or other means of retaining the identification clip.

Alternatively, the identification clip can be in the shape of a cap that fits over the end of a part. The cap could include a snap fitting on the inside that will prevent the cap from being removed inadvertently. The snap fitting could be retained by the groove. Alternatively, the snap fitting could be retained by the part itself (without the necessity of a groove). For example, if the cap was placed over the back of the fan control valve 70 or adjusting knob 75, the snap fitting could be retained by the edge of the head.

The identification clip 65 can be made in a variety of colors so that a particular color can be associated with a particular user and/or with a particular use for the spray gun, such as for the base coat and the clear coat. One or more identification clips can be used to identify a particular spray gun. For example, one user may have a blue identification clip, while another user has red identification clip, and a third user has a green identification clip. If desired, a second identification clip can be used to identify the type of gun, for example, base coat guns and clear coat guns. For example in this situation, the base coat gun for the first user would have a blue ring (user) and a black ring (use), while the clear coat gun would have a blue ring (user) and a white ring (use).

The identification clip should be wide enough that so that it can be easily seen by the user. The identification clip is typically in the range of about 0.5 and about 5.0 mm, although it could be narrower or wider if desired. If the identification clip has a space between the ends (for example, a C-shaped identification clip), the space should be large enough that it can be placed around the air inlet fitting, but not so large that it could fall off or be removed inadvertently. Alternatively, it could have a slit (without any space) so that it can be slipped around the part.

While certain representative embodiments and details have been shown for purposes of illustrating the invention, it will be apparent to those skilled in the art that various changes in the compositions and methods disclosed herein may be made without departing from the scope of the invention, which is defined in the appended claims.

What is claimed is:

1. A fluid applicator comprising:
a body having a nozzle and trigger and optionally at least one part connected to the body, the body having a groove therein; and
a removable color-coded identification clip made of a flexible material positioned in the groove in the body.

2. The fluid applicator of claim 1 wherein the flexible material is selected from plastic, rubber, or combinations thereof.

3. The fluid applicator of claim 2 wherein the plastic is selected from acetal, polyethylene, nylon, or combinations thereof.

4. The fluid applicator of claim 1 wherein the part connected to the body comprises an air inlet fitting, and wherein the groove is located on the air inlet fitting.

5. The fluid applicator of claim 1 wherein the groove is located on a part selected from the trigger, a handle, the nozzle, a body bushing, or an air valve, or combinations thereof.

6. The fluid applicator of claim 1 wherein there are at least two identification clips positioned in the groove.

7. The fluid applicator of claim 1 wherein the identification clip has a shape selected from C-shaped, square, hexagonal, or circular.

8. The fluid applicator of claim 1 wherein the identification clip has a continuous shape.

9. A fluid applicator comprising:
a body having a nozzle, a trigger, and optionally at least one part connected to the body; and
a removable color-coded identification clip made of a flexible material snapped onto the body.

10. The fluid applicator of claim 9 wherein the flexible material is selected from plastic, rubber, or combinations thereof.

11. The fluid applicator of claim 10 wherein the plastic is selected from acetal, polyethylene, nylon, or combinations thereof.

12. The fluid applicator of claim 9 wherein the identification clip has a shape selected from C-shaped, square, hexagonal, or circular.

12. The fluid applicator of claim 9 wherein the identification clip has a continuous shape.

13. The fluid applicator of claim 9 wherein the identification clip is a cap.

14. The fluid applicator of claim 9 wherein the body has a groove and wherein the identification clip is snapped onto the groove in the body.

15. A method of identifying a fluid applicator comprising:
providing a fluid applicator having a groove therein,
selecting a removable color-coded identification clip made of a flexible material; and
inserting the identification clip in the groove in the fluid applicator.

16. The method of claim 15 wherein the flexible material is selected from plastic, rubber, or combinations thereof.

17. The method of claim 16 wherein the plastic is selected from acetal, polyethylene, nylon, or combinations thereof.

18. The method of claim 15 wherein the groove is located on an air inlet fitting, a trigger, a handle, a nozzle, a body bushing, or an air valve, or combinations thereof.

19. The method of claim 15 wherein the identification clip has a shape selected from C-shaped, square, hexagonal, or circular.

20. The method of claim 15 wherein the identification clip has a continuous shape.

21. The method of claim 15 wherein providing a fluid applicator having a groove therein comprises providing a fluid applicator and machining a groove in the fluid applicator.
